(19) United States
(12) Patent Application Publication
(10) Pub. No.: US 2016/0019366 A1
(43) Pub. Date: Jan. 21, 2016

(54) Method for Validation of Pharmaceutical Composition Formulations

(71) Applicant: Paul P. Klomp, Sugar Land, TX (US)

(72) Inventor: Paul P. Klomp, Sugar Land, TX (US)

(21) Appl. No.: 14/334,270

(22) Filed: Jul. 17, 2014

(51) Int. Cl. G06F 19/00

(52) U.S. Cl. CPC G06F 19/3456; G06F 19/327

(57) ABSTRACT

A method for validating pharmaceutical composition formulations is disclosed. The method may involve a pharmaceutical composition validation system, which may include a pharmaceutical manufacturing process, a barcode scanning, weighing the pharmaceutical compositions with a pharmaceutical scale, sending the barcode scanned data and weight information to a database, and having a user accessing the information through a user interface. Additionally, the method for validating pharmaceutical compositions may include entering inventory data into the system, formulating the batch, storing compounding data, manufacturing the batch, assigning and printing a barcode on the pharmaceutical products, scanning the barcode, checking if correct chemicals are used and correct the pharmaceutical compositions if necessary, weighing the pharmaceutical compositions, populating and storing the weight data, checking if weight is correct in pharmaceutical compositions, and correcting the weight of pharmaceutical compositions.

### CROSS-REFERENCE TO RELATED APPLICATIONS

The disclosure herein described is a sister application of U.S. Ser. No. 13/900,332 entitled “System and Method for Validation of Pharmaceutical Composition Formulations,” and U.S. Ser. No. 13/900,341 entitled “Method for Validation of Pharmaceutical Formulation Composition Weight.”.

### BACKGROUND

1. Field of the Disclosure

The present disclosure relates generally to pharmaceutical operations, and more particularly, to a method for validating pharmaceutical composition formulations.

2. Background Information

In order to fulfill patient prescriptions, pharmacies stock and manage an extensive inventory of pharmaceutical products. These products are packaged in pharmaceutical product containers including any suitable type of package such as bottles, boxes, and bags, among others. To keep track of the different items in inventories, as well as for reducing number of medication errors in hospitals and healthcare centers, the US Food and Drug Administration (FDA) has specified that the packaging of all human drugs be labeled with a linear bar code including the National Drug Code (NDC) number that serves as a universal product identifier. This 10-digit code identifies the labeler/vendor, product, trade package size, the specific strength, the dosage, and the formula for a specific firm. These barcodes exhibit benefits such as improving operational efficiency, saving time for tracking inventory, reducing errors, and cutting inventory costs.

Problems related with present pharmaceutical control operations include that after the scanning of barcodes, software generally require users to manually input the lot number of the item that was scanned or sometimes other identification data, which may lead to type-off mistakes. Additionally, when producing pharmaceuticals and scanning their barcodes, information included in the barcodes does not generally permit a system to detect if a pharmaceutical has the wrong chemicals in the right concentrations. This may cause quality control having to check for quality at the end of the manufacturing process, leading to monetary and material costs due to the disposal of many of the products in the batch.

Furthermore, generally after scanning barcodes from pharmaceutical compositions, these are weighed in pharmaceutical scales, after which a pharmacist may print a weight receipt according to the weight measured by the scale. Afterwards, this weight is hand-typed into the system, but because the system does not ensure that the pharmaceutical composition has the correct weight, the process may continue without any automatic weight validation process. Additionally, hand-typing the weight of the pharmaceutical compositions may lead to type-off mistakes, and consequently quality and monetary losses. Quality control and efficiency of pharmaceutical operations are considered to be a major concern.

### SUMMARY

The present disclosure relates to a method for validating pharmaceutical compositions. The method may involve a pharmaceutical composition validation system, which may include a pharmaceutical manufacturing process, a barcode scanning, weighing the pharmaceutical compositions with a pharmaceutical scale, sending the barcode scanned data and weight information to a database, and having a user accessing the information through a user interface. Additionally, the method for validating pharmaceutical compositions may include entering inventory data into the system, formulating the batch, storing compounding data, manufacturing the batch, assigning and printing a barcode on the pharmaceutical compositions, scanning the barcode, checking if correct chemicals are used and correct the pharmaceutical compositions if necessary, weighing the pharmaceutical compositions, populating and storing the weight data, checking if weight is correct in pharmaceutical compositions, and correcting the weight of pharmaceutical compositions.

When producing the batch and after assigning, printing, and scanning the barcode on the pharmaceutical compositions, the method may compare the original compounding data with the data on the produced pharmaceutical compositions, such that the batch may be stopped until it has been corrected, saving time and economical resources because ingredients in the batch may still be utilized. Data comparison may include factors such as chemical composition, purity, potency, waters of hydration, and loss of drying, among others.

After ensuring that correct chemicals are being utilized, the method may weigh the pharmaceutical compositions and may populate and store this data in the database for a weight check to be performed. If the pharmaceutical composition's measured weight does not match the predetermined weight, the method may include correcting the weight by adding or removing quantities of chemicals to the pharmaceutical composition, thus improving accuracy and efficiency of quality control. In addition, after weighing pharmaceutical compositions, scale information, including last calibration, date/time, and the serial number of the scale, are also stored in the database, which may assist in improving pharmaceutical compositions' traceability.

Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a block diagram of a pharmaceutical composition validation system, according to an embodiment.

FIG. 2 is a flowchart of a method for validating pharmaceutical compositions in a pharmaceutical manufacturing process, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Pharmaceutical composition” refers to a pharmaceutical dosage form, such as a tablet, capsule, and solution, among others, generally including an active ingredient in association with inactive ingredients.

“Composition validation” refers to a process for providing a high degree of assurance that pharmaceutical compositions meet predetermined specifications and quality attributes.

“Weight validation” refers to a process for providing a high degree of assurance that pharmaceutical compositions meet predetermined specifications related to the quantity of chemicals in the pharmaceutical compositions.

“Batch” refers to a specific quantity of a pharmaceutical composition or other material that may be intended to have uniform character and quality, within specified limits, and may be produced according to a single manufacturing order during the same cycle of manufacture.

“Lot number” refers to a distinctive combination of letters, numbers, or symbols, or any combination thereof, from which a complete history of a manufacture, processing, packing, holding, and distribution of a batch or lot of pharmaceutical composition or other material may be determined.

### DESCRIPTION OF THE DRAWINGS

The present disclosure relates to a method for validating formulations in pharmaceutical compositions, which may allow the tracking of each ingredient within pharmaceutical compositions and may stop the manufacturing process in cases where predefined characteristics in the pharmaceutical compositions do not match measured values, allowing the batch to be corrected before finishing production. Additionally, when scanning pharmaceutical compositions, data is populated in a way that there may not be need to hand-type information into the system. After scanning a barcode, pharmaceutical compositions may be weighed and the weighing information may be stored into a database. Subsequently, the method may include analyzing if the pharmaceutical compositions include the correct weight. In cases where weight is incorrect, the method may include preventing the process to continue until the weight of pharmaceutical compositions has been corrected.

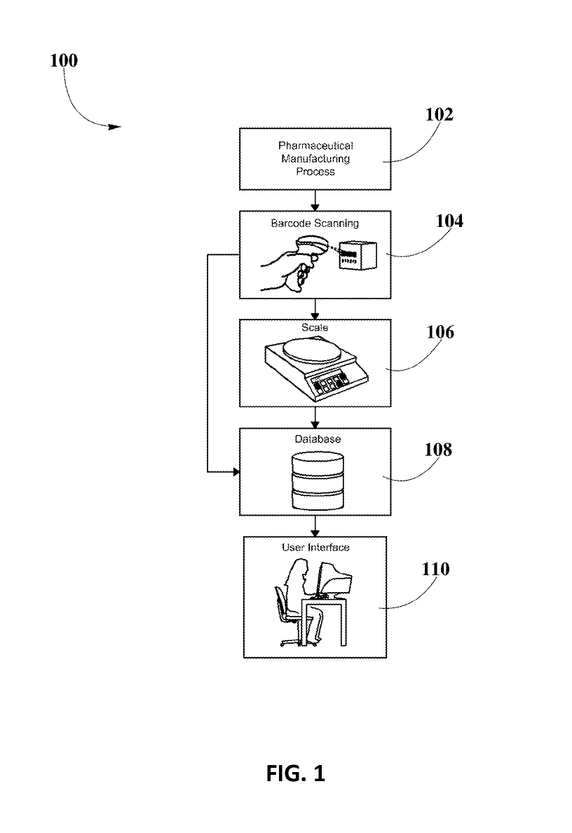

FIG. 1 is a block diagram of pharmaceutical composition validation system 100, which may include a pharmaceutical manufacturing process 102, in which, after a pharmaceutical composition may be manufactured, packaged, and a barcode has been assigned and printed on the product, a barcode scanning 104 may follow. After barcode scanning 104, the pharmaceutical composition may be weighed in a scale 106. Then, both the information from barcode scanning 104 and the weight information from scale 106 may be stored automatically in a database 108, which may be connected to a computer device that may display a user interface 110, thus permitting a pharmacist to access the inventory and data from each product and ingredient in the manufactured batch, including pharmaceutical composition weights. In present disclosure, computer device may include desktop computers, laptop computers, among others. Additionally, database 108 may save information and calculations from pharmaceutical compositions manufactured in previous batches.

Suitable barcode symbols that may work with the principles of the present disclosure include EAN/UPC, Code 128, and Code 3 of 9, among others.

Suitable barcode scanners 104 may include a wide variety of form factors, including fixed location, hand-held, fixed/hand-held, and wearable, among others.

Suitable scales 106 may include Denver TL-603D, TL Series, TC Series; Denver XL-410D, XL-610, XL-1810, XL-3100, XL-410D, XL-3100D, AL-400D; Scientech SP; Scientech ZSP Precisa XT Series; A&D; Sartorius CP; Mettler Toledo; Shimadzu AW 220; and Ohaus Discovery, among others.

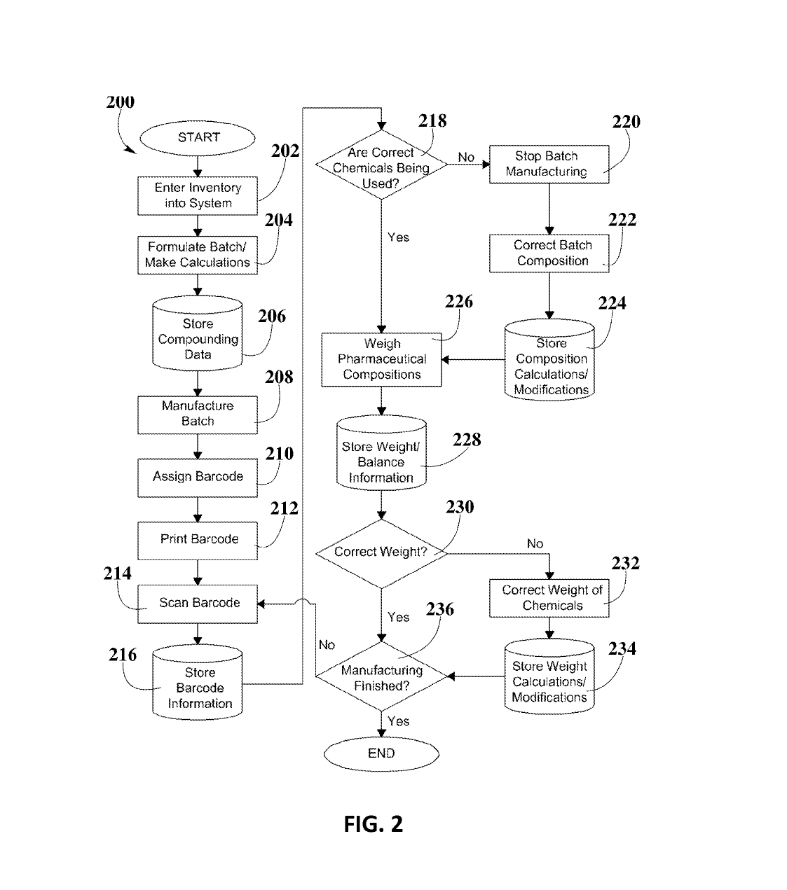

FIG. 2 is a flowchart of a method for validating pharmaceutical compositions 200 in pharmaceutical manufacturing process 102. Method for validating pharmaceutical compositions 200 may begin when the individual pharmacist in charge of producing a batch enters inventory data into the system 202, which may be performed every time inventory is received in the pharmacy. Subsequently, the individual pharmacist may formulate the batch 204, which may involve making necessary calculations of factors such as purity, potency, waters of hydration, loss of drying, and weight of chemicals, among others. Different ranges for the different factors may be assigned to each pharmaceutical formulation. Formulating the batch 204 may depend on production planning based on individual patient prescriptions. Information gathered for each individual ingredient in pharmaceutical compositions in the batch may then be stored in database 206, after which batch manufacturing 208 may begin.

After a pharmaceutical composition is produced, method for validating pharmaceutical compositions 200 may assign a barcode 210, which may include information of the individual pharmaceutical composition that has been produced, including aforementioned factors (purity, potency, waters of hydration, and loss of drying) and other data such as lot number, expiration date, national drug code (NDC), average wholesale price (AWP), manufacturer, and cost, among others. After assigning a barcode 210, a process for printing the barcodes 212 on each of the individual pharmaceutical compositions may follow. Subsequently, each barcode may be scanned 214, leading to barcode data storage 216 for data to be populated such that a pharmacist may have access to this data in database 108 using a computer device displaying user interface 110. The pharmacist may have access to the inventory and to all the ingredients in the individual pharmaceutical compositions, including the ingredients' original batch, location, weight, and concentrations, among others, without the need of hand-typing the lot number or other data, saving time and increasing data accuracy.

Method for validating pharmaceutical compositions 200 may subsequently check if correct chemicals are being used 218 within the scanned pharmaceutical composition, which may be performed by comparing predefined values for pharmaceutical compositions with values in the scanned information. If values do not match, method for validating pharmaceutical compositions 200 may proceed by stopping batch manufacturing 220 and then correcting batch composition 222. Correcting batch composition 222 may include modifying chemicals, purity, potency, waters of hydration, and loss of drying or other factors that may have varied between the data for batch formulation 204 and pharmaceutical composition characteristics in the actual batch manufacturing 208. After ensuring that correct chemicals are being used with predefined characteristics, method for validating pharmaceutical compositions 200 may store the new pharmaceutical compositions calculations and modifications 224 in database 108.

Method for validating pharmaceutical compositions 200 may continue by weighing pharmaceutical compositions 226, after which weight/scale information may be automatically stored 228 in database 108. Storing weight/scale information 228 may include storing the measured weight of the pharmaceutical compositions as well as storing information about the scale that was employed, including last calibration, date/time, and the serial number of the scale, among others. Subsequently, method for validating pharmaceutical compositions 200 may check pharmaceutical compositions weight 230, in which the measured pharmaceutical composition's weight is compared to the predetermined weight, assigned when formulating the batch 204. When checking pharmaceutical compositions weight 230, method for validating pharmaceutical compositions 200 may take into account the weight ranges to which the pharmaceutical compositions have been set, such that if the difference between the measured pharmaceutical composition's weight and the predetermined weight falls within the range, no modification may have to be made. Otherwise, if the difference between the measured pharmaceutical composition weight and the predetermined value does not fall within the weight range assigned to the pharmaceutical composition, method for validating pharmaceutical compositions 200 may correct pharmaceutical compositions weight 232, which may include determining the quantities of chemicals that may need to be added or removed from the pharmaceutical composition in order to achieve the predetermined weight, and adding or removing the chemicals accordingly. After correcting pharmaceutical compositions weight 232, weight calculations and modifications may be stored 234 in database 108.

Finally, method for validating pharmaceutical compositions 200 may determine if the manufacturing process has finished 236, in which case the process may end. Otherwise, method for validating pharmaceutical compositions 200 may scan the barcode 214 of another pharmaceutical composition until the process may end.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for validating a formulation in a pharmaceutical composition, the method comprising:
providing, to a non-transitory computer readable storage medium having encoded thereon computer executable instructions for providing at least one inventory control system, at least one batch protocol comprising at least one compound formula;
associating a unique identifier for labeling manufactured product with the at least one batch protocol;
weighing the composition of one of the manufactured product and providing at least one comparison to at least one compound weight;
analyzing a composition of one of the manufactured product; and
comparing the composition to the at least one compound formula;
wherein the inventory control system provides an indication of the comparison between the composition of one of the manufactured product and the at least one compound formula.

2. The method of claim 1, wherein the at least one batch protocol is changed by the indication of the comparison between the weight of one of the manufactured product to the at least one compound weight.

3. The method of claim 2, wherein a change of the at least one batch protocol comprises one selected from the group consisting of change in compound formula, compound quantity, compound potency, and combinations thereof.

4. The method of claim 1, wherein the at least one inventory control system is changed by the indication of the comparison between the composition of one of the manufactured product to the at least one compound formula.

5. The method of claim 1, wherein the comparison between the composition of one of the manufactured product and the at least one compound formula is between at least one selected from the group consisting of chemical composition, purity, potency, waters of hydration, loss of drying, and combinations thereof.

6. The method of claim 1, wherein the unique identifier comprises at least one lot number.

7. The method of claim 1, wherein the at least one compound formula comprises at least one individual ingredient attribute selected from the group comprising molar weight, name, color, interaction profile, stability profile, and combinations thereof.

8. The method of claim 1, wherein the unique identifier is a barcode.

9. The method of claim 1, wherein the unique identifier is selected from the group consisting of EAN/UPC, GS1 Data Matrix, GS1 DataBar, GS1-128, ITF-14, GS1 QR Code, and combinations thereof.

10. The method of claim 1, wherein the unique identifier is read by one selected from the group consisting of a fixed location scanner, hand-held scanner, a wearable scanner, a pen-type scanner, a CCD reader, a laser scanner, a camera-based reader, and combinations thereof.

11. The method of claim 1, wherein the at least one comparison to at least one compound weight is associated to the unique identifier.

12. The method of claim 1, wherein the at least one compound weight is selected from a predetermined range.
